(19) United States
(12) Patent Application Publication
(10) Pub. No.: US 2024/0189899 A1
(43) Pub. Date: Jun. 13, 2024

(54) Titanium Grain Refinement In Additive Manufacturing

(71) Applicant: Lockheed Martin Corporation, Bethesda, MD (US)

(72) Inventors: Zachary Loftus, Littleton, CO (US); Scott William Cochran, Littleton, CO (US); Michael A. Reale, San Jose, CA (US); Scott Wesley Smith, Palo Alto, CA (US)

(73) Assignee: Lockheed Martin Corporation, Bethesda, MD (US)

(21) Appl. No.: 18/061,698

(22) Filed: Dec. 5, 2022

Related U.S. Application Data
(60) Provisional application No. 63/361,383, filed on Dec. 15, 2021.

(51) Int. Cl. B22F 1/12

(52) U.S. Cl. CPC B22F 1/12; B33Y 70/10

(57) ABSTRACT

Provided herein are various enhancements for additive manufacturing using titanium and titanium alloy materials. In one example, a method includes inoculating a titanium material with ceramic particles that produce nucleation sites within the titanium material during successive melt and solidification steps of an additive manufacturing process. The nucleation sites promote grain nucleation during solidification of molten titanium material into solid titanium material during the additive manufacturing process.

### RELATED APPLICATIONS

This application hereby claims the benefit of and priority to U.S. Provisional Patent Application 63/361,383, titled “TITANIUM GRAIN REFINEMENT IN ADDITIVELY MANUFACTURED PRODUCTS,” filed Dec. 15, 2021, which is hereby incorporated by reference in its entirety.

### TECHNICAL BACKGROUND

Titanium and titanium alloys are popular for space and aerospace applications for corresponding strength, durability, and weight properties. However, working with titanium can pose difficulties, especially in modern and emerging additive manufacturing techniques, such as 3D printing. Various additive manufacturing techniques have been developed to manufacture with metallic substances. One example additive manufacturing technique is directed energy deposition which uses lasers, electron beams, or plasma arcs to selectively deposit and fuse powered or wire-fed metallic materials. Another example additive manufacturing technique is powder bed fusion which builds up successive layers by selectively fusing layers of powered metal. Powder bed fusion includes selective laser melting (SLM), direct metal laser sintering (DMLS), electron beam melting (EBM), and other techniques. In these techniques, among others, a source material is sequentially melted and resolidified at spatial locations to form various manufactured objects.

Unfortunately, metallic additive manufacturing can create large grains in titanium and titanium alloys which impede non-destructive examination of a component and can produce varied physical properties of the component along different axial directions. Specifically, when a melt pool solidifies during sequential melt/solidify steps, large thermal gradients create preferential epitaxial solidification/grain growth directions which are often retained across subsequent material deposition passes during the additive manufacturing process, resulting in large asymmetric grains that span multiple deposition layers. These large grains can inhibit or reduce the effectiveness of inspection techniques from detecting internal defects or voids in heavy or large sections of material. Manufactured products can be examined using many types of non-destructive examination techniques. Some non-destructive examination techniques can include radiographic and ultrasonic examination techniques. Ultrasonic inspection is typically employed, instead of radiography, in heavy sections due to inspection sensitivity. The inability to adequately inspect heavy section components using ultrasonic techniques in materials having large grains can restrict the usage of additive manufacturing, particularly directed energy deposition, for many applications.

### Overview

Provided herein are various enhancements for additive manufacturing using titanium and titanium alloy materials. The examples herein can provide for reduced inter-layer epitaxial solidification/grain growth during an additive manufacturing process. An inoculant can be introduced into a titanium material to produce various feedstocks for additive manufacturing, including powdered forms, ingots, or filled core wire forms. When employed in additive manufacturing processes, such as directed energy deposition or powder bed fusion, the feedstock material exhibits advantageous properties in the target objects produced, such as finer grains, more equiaxed grains, and increased viability of ultrasonic inspection techniques for discovery of voids and defects.

In one example, a method includes inoculating a titanium material with ceramic particles that act as nucleation sites within the titanium material during the successive melt and solidification steps of an additive manufacturing process. The nucleation sites promote grain nucleation during solidification of molten titanium material into solid titanium material during the additive manufacturing process.

In another example, a composite material is provided that includes a titanium material and an inoculant. The inoculant comprises ceramic particles embedded within the titanium material that promote a generally equiaxed microstructure and reduces epitaxial solidification/grain growth across successive layers of the titanium material during an additive manufacturing process. The inoculant can provide nucleation sites within the titanium material during successive melt and solidification steps of the additive manufacturing process to reduce grain asymmetry in the titanium material.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates example composite materials in an implementation.

FIG. 2 illustrates grain morphology without and with an inoculant in an implementation.

FIG. 3 illustrates a method of manufacturing with a feedstock material in an implementation.

### DETAILED DESCRIPTION

Additive manufacturing using metals or metal alloys has increased in popularity, but use of certain metal materials brings several drawbacks including the creation of large/elongated asymmetric grains. For example, additive manufacturing using titanium and titanium alloys during successive material deposition steps can generate large asymmetric grains that span many layers from the repeated melting and solidification steps involved. These elongated grains can limit the effectiveness of non-destructive examination of a finished component from detecting internal defects or voids, such via as ultrasonic inspection. There are efforts to develop advanced non-destructive examination techniques to inspect for defects or voids in materials having such grains. However, even with successful inspection, these grains can produce undesirable material properties. In some manufacturing techniques, hot isostatic pressing (HIP) post-processing can reduce voids or defects in manufactured elements, but this HIP is an added manufacturing step and does not typically reduce grain size within the materials. Ultrasonic grain refinement can also produce smaller grain sizes, but requires a sonotrode inserted into in a melt pool of the material, which precludes effective use in many forms of additive manufacturing and is mostly appropriate for larger melt pools used in conventional casting or molding.

The enhanced techniques and examples herein address the underlying issues that create long asymmetric grains in titanium materials when used in additive manufacturing. Titanium materials, as discussed herein, include elemental or pure titanium (Ti), titanium alloys, titanium superalloys, titanium-based metallic materials, titanium-based metallic alloys, titanium alloy-based composite materials, and standardized titanium alloys, such as Ti-6Al-4V and other standardized titanium alloy grades and titanium compositions. The techniques herein can be applied to existing titanium materials and to any compatible titanium materials which may be developed or standardized. Advantageously, the techniques herein produce manufactured items having a more favorable microstructure that produces better material properties due to the finer and more equiaxed grain size. The examples herein have reduced formation of long asymmetric grains in titanium or titanium alloys by promoting grain nucleation sites due in part to the addition of ceramic grain refiners, such as borides, nitrides, carbides, or oxides to feedstock material. Titanium diboride has been shown in aluminum alloys to prevent large grain formation for the purpose of preventing solidification cracking. However, applied to titanium alloys, these additions can enable the successful non-destructive examination using ultrasonic inspection and other non-destructive examination techniques to heavy section components. Finer and more equiaxed grains also typically improve material properties for many applications.

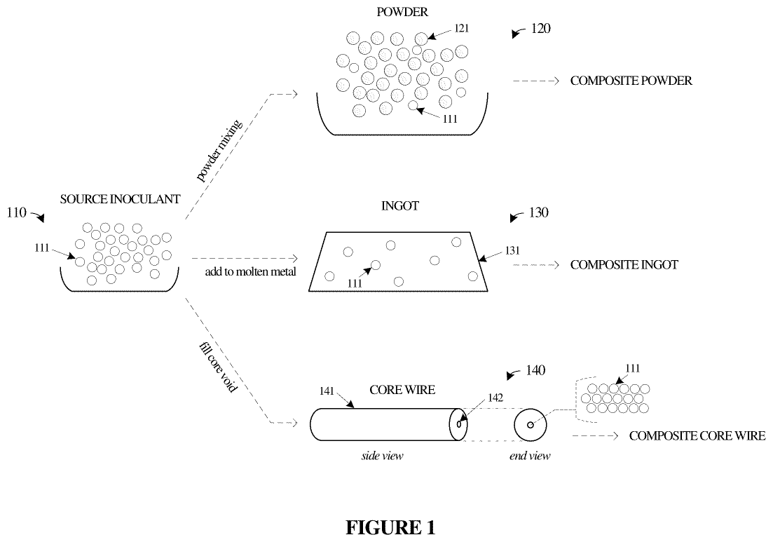

Turning now to set of examples, FIG. 1 is presented. FIG. 1 includes source inoculant 110 which can be used in various forms or states to produce feedstock for additive manufacturing processes. Notably, three example feedstock configurations 120, 130, and 140 are shown in FIG. 1, but the implementations herein are not limited to such configurations.

Source inoculant 110 is shown comprising a particulate form of material state, which includes many such inoculant particles 111. This particulate form includes solid and generally similarly sized micron-scale or smaller particles of a selected inoculant material. Example sizes include approximately 20 micrometers (microns or μm) down to the nanometer scale. Example materials include various ceramic materials or ceramic beads formed from various ceramic boride, nitride, carbide, and oxide materials. While not limited to such materials, example ceramic materials can include titanium diboride or tungsten carbide. Also, while the term ceramic is employed herein, variations of ceramic materials can also be employed, such as quasi-ceramics, among other designations. The size and type of inoculant material selected for source inoculant 110 can vary based on application, such as to obtain target grain properties in the inoculated titanium composite material or based on the additive manufacturing process.

Source inoculant 110 can be employed as an additive into various materials to enhance properties of the materials when used in additive manufacturing processes. Specifically, source inoculant 110 may be added to a titanium or titanium alloy feedstock to reduce the grain size in additively manufactured products. In the depicted examples, source inoculant 110 can be added to titanium alloy powders (120), ingots (130), or core wire (140), among other feedstock types. Advantageously, these additives in the titanium alloy can establish grain nucleation sites during additive manufacturing melt/solidification processes, producing many smaller equiaxed grains rather than fewer larger and asymmetrically longer grains.

Turning first to powder feedstock configuration 120, source inoculant particles 111 can be mixed with titanium feedstock power particles 121. Titanium feedstock power particles 121 comprise a powdered state or form of titanium or titanium alloy which can be employed in powder bed fusion or directed energy deposition additive manufacturing processes. A mixing can be performed among titanium feedstock power particles 121 and source inoculant particles 111 to produce a composite powdered material used as a feedstock material. In some examples, the mixing occurs until a target or threshold level of homogeneity among titanium feedstock power particles 121 and source inoculant particles 111 is reached. While the mixing can occur prior to manufacturing processes, such as to produce bulk feedstock for manufacturing, it should be understood that the mixing might instead occur during manufacturing. For example, outputs from a hopper of titanium feedstock power particles 121 and a hopper of source inoculant particles 111 can be combined at a selected flow rate during manufacturing. Alternatively, a powder bed material can have a hopper loaded with a pre-mixed material.

In the second example, ingot feedstock configuration 130 is illustrated. Source inoculant particles 111 can be added to titanium feedstock ingot material 131 while titanium feedstock ingot material 131 is in a molten state. In this configuration, source inoculant particles 111 are selected to be insoluble in titanium feedstock ingot material 131 and have a higher melting point than the temperatures employed to produce the molten state of titanium feedstock ingot material 131. Thus, a mechanical mixing is performed to combine the two materials into a composite feedstock material. In some examples, the mixing occurs until a target or threshold level of homogeneity among titanium feedstock ingot material 131 and source inoculant particles 111 is reached. Once the inoculated ingot material is cooled or solidified, then the composite ingot material can be used as a feedstock material. This composite ingot material might be prepared into a powder, wire, or other form to be used in a selected additive manufacturing process. For example, the composite ingot material can be drawn into a spooled wire used for a wire-fed additive manufacturing process, which may include drawing the wire when the composite ingot has not cooled from the molten state or re-softening the composite material.

In the third example, core wire feedstock configuration 140 is illustrated. Source inoculant particles 111 can be added to hollow core 142 of core wire feedstock 141. Core wire feedstock 141 comprises a drawn wire material having a hollow core which can accept various materials. In this example, the material inserted into the core comprises source inoculant particles 111. Source inoculant particles 111 might be in a powdered form, or combined with a binder material, glue, gel, flux, or other material to produce a core material that includes source inoculant particles 111. Source inoculant particles 111 is then injected into the cavity formed by the hollow core of core wire feedstock 141, forming a composite wire material having a cylindrical tube of titanium or titanium alloy material surrounding a central cylinder of source inoculant particles 111. The composite wire material can be spooled and used for a wire-fed additive manufacturing process.

In the three configurations noted above, a selected ratio of source inoculant particles 111 and base feedstock material can be employed when producing the composite feedstock material. Example ratios include under 1 percent by volume (% by vol.) in typical use cases, but exact amounts can vary up to approximately 5% by vol. Of course, the percentage by volume can vary based on the inoculant material, the base feedstock material, the application, and the additive manufacturing material, among other factors.

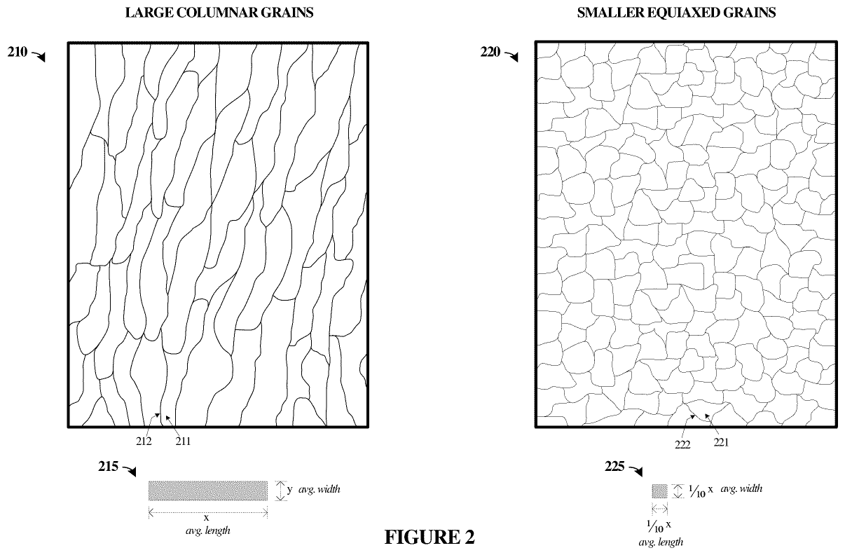

FIG. 2 is now presented which includes two examples of microstructural development or grain morphology for additively manufactured items with and without the inoculated composite feedstocks noted in FIG. 1. View 210 illustrates large columnar grain microstructure in a titanium material produced using an additive manufacturing technique without inoculated composite feedstock. View 220 illustrates smaller equiaxed grain microstructure in a titanium material produced using an additive manufacturing technique with inoculated composite feedstock.

As can be seen in view 210, grains (exemplified by grain 211) each have grain borders (212) that define the extent of the individual grains. The grains seen in view 210 are asymmetric with respect two at least two axes, producing long, extended columnar grain configurations. An example metric 215 for grain thickness is shown below view 210, indicating an average length and width for the grains seen in view 210. Specifically, a length of ‘x’ and a width of ‘y’ is shown. Exact measurements for x and y in FIG. 2 can vary, such as millimeter scale (or larger) for x and hundreds of microns for y, although variations are possible. It should be noted that some grains are shorter than the average shown in metric 215, while others are much longer. These columnar grain structures arise from the additive manufacturing processes. Specifically, previously formed layers define grain microstructures which act as seeds for the new layers for continuation and growth during repeated melting and re-solidification of material to form each new layer. Conventional additive manufacturing processes for titanium materials, such as directed energy deposition, can create large thermal gradients as the melt pool solidifies for each layer, creating preferential epitaxial solidification/grain growth directions, which are often retained with each subsequent deposition path, resulting in length-extended grains. Thus, long columnar grains are formed over successive build-up of layers. These long, columnar, grains can result in lower mechanical properties for the resulting product and inhibit non-destructive inspection of parts made using such material.

Further, in certain applications, no- or low-temperature heat treatment typically does not reduce large grains that are formed as a result of thermal gradients as the melt pool solidifies during the additive manufacturing processes. As described herein, manufactured products can be examined prior to use with nondestructive examination techniques. In some applications, conventional radiographic examination techniques may not provide sufficient sensitivity to examine additively manufactured products with heavy sections. Therefore, ultrasonic examination techniques can provide additional sensitivity compared to radiographic examination techniques to examine additively manufactured products with heavy sections. However, additively manufactured products with large grains, such as seen in view 210 for products conventionally additively manufactured from non-inoculated titanium materials, may impede ultrasonic examination of a component. For example, large grains can prevent ultrasonic inspection techniques from detecting defects or voids in heavy sections. Therefore, in some applications, certain parts additively manufactured from titanium materials with heavy sections may not be properly inspected, and might not be suitable to be placed into service. Accordingly, the external dimensions of parts additively manufactured from non-inoculated titanium materials by certain techniques may be limited by the capabilities of an ultrasonic inspection process.

As can be seen in view 220, grains (exemplified by grain 221) each have grain borders (222) that define the extent of the individual grains. The grains seen in view 220 are more symmetric as compared to those in view 210 with respect two at least two axes, producing smaller, more equiaxed grain configurations. An example metric 225 is shown for grain thickness below view 220, indicating an average length and width for the grains seen in view 220. Specifically, lengths and widths on the order of approximately 1/10x are shown, although variations are possible. It should be noted that some grains are larger than the average shown in metric 225, while others are much smaller. These equiaxed grain structures arise from the additive manufacturing processes enhanced with an inoculated feedstock material, such as those detailed in FIG. 1. Specifically, previously formed layers define grain microstructures which act as seeds for the new layers for continuation and growth during repeated melting and re-solidification of material to form each new layer. Conventional additive manufacturing processes for titanium materials, such as directed energy deposition, can create large thermal gradients as the melt pool solidifies for each layer, creating preferential epitaxial solidification/grain growth directions, which are often retained with each subsequent deposition path, resulting in length-extended grains. Thus, long columnar grains are formed over successive build-up of layers. These long, columnar, grains can result in lower mechanical properties for the resulting product and inhibit non-destructive inspection of parts made using such material.

Thus, the example seen in view 220 can result in titanium materials and corresponding additively manufactured products with smaller equiaxed grains, which can allow for ultrasonic inspection of resulting products, including products with heavy sections. Further, titanium material additively manufactured products with smaller grains can have improved mechanical properties compared to products with larger grains. The inoculant employed with the titanium material creates grain nucleation sites during additive solidification, which produces a microstructure with many smaller grains rather than fewer large/long grains. The inoculant particles within the titanium material can act to disrupt the process of grain extension in additive manufacturing during repeated melt/solidification events for each new layer of material added. The inoculant particles promote nucleation of newly solidified grains from the liquid state, which acts to limit grain growth via competitive nucleation among grains. While the discussion above refers to the desire to reduce the quantity of large asymmetric grains in a titanium material microstructure, the reduction in relative length is just one grain metric to consider. Another grain metric is to ensure that grains are also more equiaxed in extent over in two or three axes with respect to other grains.

To achieve the above microstructure enhancements, a titanium material is combined with an additive or inoculant into a composite material comprising a mixture of the additive or inoculant at under approximately 1% per volume in the titanium material, although the exact ratios per volume can vary based on application, and may as high as approximately 5% by volume and as low as approximately 0.1% by volume. This composite material, when deployed as a feedstock in an additive manufacturing process, can produce reduced grain growth across layers and within layers to establish generally equiaxed grains within the titanium material of approximately sub-millimeter scale, which can be orders of magnitude smaller than with non-inoculated titanium feedstock materials.

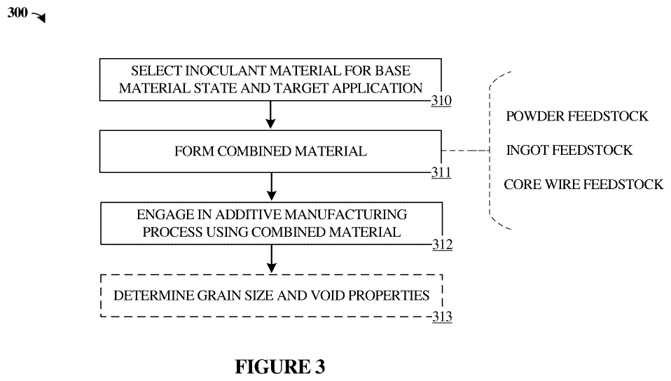

FIG. 3 illustrates an example method 300 of manufacturing with an inoculated feedstock material in an implementation. In operation 310, an inoculant material is selected for a base material state and a target application. The inoculant material typically comprises ceramic particles selected from any of the aforementioned materials. These ceramic particles can comprise ceramic beads, ceramic powder, ceramic flakes, ceramic chips, or other ceramic forms. The base material can include titanium metal or any titanium alloy, and the inoculant can be selected based in part on the base material selected, as well as the state of the base material. For example, the base material state may include powdered, ingot, core wire, ground, particles, or other state. Also, the selected inoculant may vary based on the part or workpiece application, size, environmental conditions, or geometric configuration.

Once the inoculant is selected, a combined feedstock material can be made in operation 311. This can include any of the feedstocks mentioned in FIG. 1, among others. For example, a power feedstock can be made by combining inoculant particles with titanium material in a powdered state, an ingot feedstock can be made by combining inoculant particles with titanium material in a molten state, and a core wire feedstock can be made by introducing inoculant particles into a hollow core of a hollow core wire.

After the inoculated or composite feedstock has been established, then additive manufacturing processes can proceed in operation 312. This additive manufacturing processes can include at least one among a directed energy deposition additive manufacturing process and powder bed fusion additive manufacturing process, among others. As discussed herein, additive manufacturing processes typically build workpieces or parts layer-by-layer by depositing material and melting such material in selected positions that attach or merge with previous layers. The repeated melt and solidification among individual layers and between layers can contribute to large asymmetric grain formation in the base material (e.g., titanium material). The use of the inoculant can reduce this tendency, and produce workpieces with more equiaxed grain microstructure.

In other examples, the feedstock can be mixed or made on-the-fly during additive manufacturing processes. In this manner, the quantity of inoculant might be varied for certain portions of the workpiece being manufactured. For example, for thick or heavy portions/sections of a workpiece, the ratio of inoculant might be increased (or entirely included) to increase the viability of ultrasonic inspection from more equiaxed grain production in those areas. For thinner or less heavy portions/sections of a workpiece, the ratio of inoculant might be decreased (or entirely omitted), since the risk of ultrasonic inspection failure is less. Thus, an in-situ or real-time alteration of the ratio of inoculant in a feedstock can be made depending on properties of the workpiece being additively manufactured. Moreover, different prepared feedstocks might be selected among to achieve similar ratio modification.

Finally, once the workpiece or part has been manufactured, grains sizes and void properties can be determined in operation 313. As mentioned, ultrasonic inspection can be performed on heavy/thick portions of the workpieces more effectively when the inoculant is employed in the base material. A feedback loop can be established to alter a ratio or type of inoculant based on the inspection. For example, if the grain size is still not conducive to ultrasonic inspection, then a higher ratio or different type of inoculant can be selected to build another workpiece. Likewise, if the grain size appears sufficient for ultrasonic inspection, a feedback process might continue to reduce the ratio of inoculant to establish the minimum ratio needed to produce desired workpieces with respect to material properties, microstructure, and favorable inspection properties.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various materials and manufacturing processes discussed herein are employed according to the descriptions above. However, it should be understood that the disclosures and enhancements herein are not limited to these materials and manufacturing processes, and can be applicable across a range of suitable materials and manufacturing processes. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

1. A method, comprising:
inoculating a titanium material with ceramic particles that produce nucleation sites within the titanium material during successive melt and solidification steps of an additive manufacturing process; and
wherein the nucleation sites promote grain nucleation during solidification of molten titanium material into solid titanium material during the additive manufacturing process.

2. The method of claim 1, wherein the promoted grain nucleation reduces grain asymmetry and epitaxial growth of grains across successive layers associated with the additive manufacturing process.

3. The method of claim 1, wherein the promoted grain nucleation establishes approximately equiaxed grain arrangements in the titanium material.

4. The method of claim 1, wherein the promoted grain nucleation across the successive layers increases viability of ultrasonic inspection for voids in objects made with the titanium material.

5. The method of claim 1, wherein the titanium material comprises titanium or titanium alloy.

6. The method of claim 1, wherein the ceramic particles comprise at least one among titanium diboride, tungsten carbide, or ceramic materials selected from borides, nitrides, carbides, and oxides.

7. The method of claim 1, wherein inoculating the titanium material with the ceramic particles comprises mixing the ceramic particles with the titanium material in a powdered form until a target homogeneity is achieved.

8. The method of claim 1, wherein inoculating the titanium material with the ceramic particles comprises introducing the ceramic particles into the titanium material in a molten state, and mixing the ceramic particles with the titanium material until a target homogeneity is achieved in the titanium material in the molten state.

9. The method of claim 8, comprising:
cooling the titanium material from the molten state to produce an ingot of the titanium material inoculated with the ceramic particles.

10. The method of claim 8, wherein a melting point of the ceramic particles exceeds that of a temperature used to produce the titanium material in the molten state.

11. The method of claim 1, wherein inoculating the titanium material with the ceramic particles comprises introducing the ceramic particles into a hollow core of the titanium material in a hollow core wire configuration.

12. A composite material, comprising:
a titanium material;
an inoculant comprising ceramic particles embedded within the titanium material;
wherein the inoculant is selected to establish generally equiaxed solidification of grains in the titanium material responsive to a sequence of melting and solidification that forms successive layers of the titanium material in an additive manufacturing process.

13. The composite material of claim 12, wherein the inoculant is selected to provide nucleation sites within the titanium material and reduce grain asymmetry in the titanium material by at least disrupting grain extension across the successive layers from the melting and solidification of the additive manufacturing process.

14. The composite material of claim 12, wherein the titanium material comprises titanium or titanium alloy.

15. The composite material of claim 12, wherein the ceramic particles comprise at least one among titanium diboride, tungsten carbide, or ceramic materials selected from borides, nitrides, carbides, and oxides.

16. The composite material of claim 12, wherein the additive manufacturing process comprises at least one among a directed energy deposition additive manufacturing process and powder bed fusion additive manufacturing process.

17. The composite material of claim 12 comprising a mixture of the ceramic particles with the titanium material in at least one among an ingot form and a powdered form that achieves a target homogeneity of the ceramic particles in the titanium material.

18. The composite material of claim 12 comprising the ceramic particles inserted into a hollow core of the titanium material in a hollow core wire configuration to form wire feedstock for the additive manufacturing process.

19. The composite material of claim 12 comprising a mixture of the ceramic particles at approximately 0.1% to 5% per volume in the titanium material.

20. The composite material of claim 12, wherein the generally equiaxed solidification results in generally equiaxed grains within the titanium material of approximately sub-millimeter scale.
